(19) United States
(12) Patent Application Publication
(10) Pub. No.: US 2010/0284889 A1
(43) Pub. Date: Nov. 11, 2010

(54) METHOD FOR PRODUCING HYDROCYANIC ACID BY CATALYTIC DEHYDRATION OF GASEOUS FORMAMIDE

(75) Inventors: Ralf Boehling, Lorsch (DE); Andreas Deckers, Flomborn (DE); Thomas Schneider, Frankenthal (DE); Guenther Achhammer, Mannheim (DE); Hermann Luyken, Ludwigshafen (DE); Peter Pfab, Neustadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/742,845

(22) PCT Filed: Nov. 12, 2008
(86) PCT No.: PCT/EP2008/009539

§ 371 Date: May 13, 2010

(30) Foreign Application Priority Data
Nov. 13, 2007 (EP) EP07120533.0

(51) Int. Cl. C01C 3/02; B01J 8/04

(52) U.S. Cl. 423/373; 422/196

(57) ABSTRACT

A process for preparing hydrogen cyanide by catalytically dehydrating gaseous formamide in a tubular reactor formed from at least one reaction channel in which the catalytic dehydration proceeds, said reaction channel having an inner surface which is formed from a material having an iron content of ≧50% by weight, and no additional catalysts and/or internals being present in the reaction channel, and the at least one reaction channel having a mean hydraulic diameter of from 0.5 to 6 mm, and a reactor with the features specified above and the use of the inventive reactor for preparing hydrogen cyanide by catalytically dehydrating gaseous formamide.

The present invention relates to a process for preparing hydrogen cyanide by catalytically dehydrating gaseous formamide in a tubular reactor formed from at least one reaction channel in which the catalytic dehydration proceeds, said reaction channel having an inner surface which is formed from a material having an iron content of ≧50% by weight, and no additional catalysts and/or internals being present in the reaction channel, and said at least one reaction channel having a mean hydraulic diameter of from <1 to 6 mm. The present invention further relates to a reactor formed from at least two parallel layers A and B arranged one on top of the other, the layer A having at least two reaction channels which are arranged in parallel and have a mean hydraulic diameter of from 1 to 6 mm, preferably from >1 to 4 mm, more preferably from >1 to 3 mm, and the layer B having at least two channels which are arranged in parallel and have a mean hydraulic diameter of <4 mm, preferably from 0.2 to 3 mm, more preferably from 0.5 to 2 mm, through which a heat carrier flows, the reaction channels having an inner surface formed from a material having an iron content of ≧50% by weight, and no additional catalysts and/or internals being present in the reaction channels, and to the use of the inventive reactor for preparing hydrogen cyanide by catalytically dehydrating gaseous formamide.

Hydrogen cyanide is an important commodity chemical which serves as a starting material, for example, in numerous organic syntheses such as the preparation of adiponitrile, methacrylic esters, methionine and complexing agents (NTA, EDTA). Furthermore, hydrogen cyanide is required for the preparation of alkali metal cyanides which are used in mining and in the metallurgy industry.

The majority of hydrogen cyanide is produced by converting methane (natural gas) and ammonia. In the so-called Andrussow process, atmospheric oxygen is added simultaneously. In this way, the preparation of hydrogen cyanide proceeds autothermally. In contrast, the so-called BMA process of Degussa AG works without oxygen. The endothermic catalytic reaction of methane with ammonia is therefore operated in the BMA process externally with a heating medium (methane or H₂). A disadvantage of these processes is the high unavoidable occurrence of ammonium sulfate, since the conversion of methane proceeds economically only with an NH₃ excess. The unconverted ammonia is washed out of the untreated process gas with sulfuric acid.

A further important process for preparing HCN is the so-called SOHIO process. The ammoxidation of propene/propane to acrylonitrile forms approx. 10% (based on propene/propane) hydrogen cyanide as a by-product.

A further important process for industrially preparing hydrogen cyanide is the thermal dehydration of formamide under reduced pressure, which proceeds according to the following equation (I):

HCONH₂→HCN+H₂O (I)

This reaction is accompanied by the decomposition of formamide according to the following equation (II) to form ammonia and carbon monoxide:

HCONH₂NH₃+CO (II)

Ammonia is scrubbed out of the untreated gas with sulfuric acid. Owing to the high selectivity, however, only a very small amount of ammonium sulfate is obtained.

The ammonia formed catalyzes the polymerization of the desired hydrogen cyanide and thus leads to an impairment of the quality of the hydrogen cyanide and to a reduction in the yield of the desired hydrogen cyanide.

The polymerization of hydrogen cyanide and the associated soot formation can be suppressed by the addition of small amounts of oxygen in the form of air, as disclosed in EP-A 0 209 039. EP-A 0 209 039 discloses a process for thermolytically cleaving formamide over highly sintered alumina or alumina-silica shaped bodies or over high-temperature corrosion-resistant chromium-nickel-stainless steel shaped bodies.

The prior art discloses further processes for preparing hydrogen cyanide by catalytically dehydrating gaseous formamide.

For instance, WO 02/070 588 relates to a process for preparing hydrogen cyanide by catalytically dehydrating gaseous formamide in a reactor which has an inner reactor surface composed of a steel comprising iron and also chromium and nickel, said reactor preferably not comprising any additional internals and/or catalysts.

WO 2006/027176 discloses a process for preparing hydrogen cyanide by catalytically dehydrating gaseous formamide, in which a return stream comprising formamide is obtained from the dehydration product mixture and recycled into the dehydration, said formamide-comprising return stream comprising from 5 to 50% by weight of water.

U.S. Pat. No. 2,429,262 discloses a process for preparing hydrogen cyanide by thermally decomposing formamide, wherein the formamide is decomposed catalytically by adding a solution of a substance selected from the group consisting of phosphoric acid and compounds which form phosphoric acid on thermal decomposition to a stream of formamide vapor, the mixture is heated to from 300 to 700° C. and the resulting products are cooled rapidly. According to U.S. Pat. No. 2,429,262, the formamide is preferably evaporated very rapidly to form formamide vapor. For example, the formamide can be introduced in a thin stream or in small discrete amounts into a fast evaporator heated to a temperature above the boiling point of formamide, preferably from 230 to 300° C. or higher.

U.S. Pat. No. 2,529,546 discloses a process for preparing hydrogen cyanide by thermally decomposing formamide, wherein the formamide is decomposed thermally in the vapor phase in the presence of a catalyst comprising a metal tungstate. U.S. Pat. No. 2,529,546—like U.S. Pat. No. 2,429,262—proposes evaporating formamide by using a fast evaporator with which the liquid formamide can be heated very rapidly.

According to the examples in U.S. Pat. No. 2,429,262 and U.S. Pat. No. 2,529,546, the evaporation of formamide is carried out at standard pressure at 250° C. However, it is evident from the examples in U.S. Pat. No. 2,529,546 that the selectivity in the process for preparing hydrogen cyanide disclosed in U.S. Pat. No. 2,529,546 is low.

Owing to their high temperatures needed for the catalytic dehydration of formamide, the cleavage reactors used are generally heated with circulating gas which is heated by means of flue gas. Owing to the associated poor heat transfer on the heating gas side in combination with the amount of heat needed for the dehydration, typically high heat transfer surface areas are required to introduce the heat required to dehydrate formamide. The same applies to the heat transfer at the industrially customary tube dimensions of internal diameter of generally from 10 to 100 mm for the reaction side. In addition, a mass transfer limitation occurs on the reaction side. As a result of their necessarily high heat transfer surface area, the reactors therefore constitute a considerable portion of the capital costs. Furthermore, for hydrogen cyanide production in small on-site production units (on-demand production) to avoid the transport of hydrogen cyanide or cyanides such as sodium cyanide, inexpensive compact reactors which preferably have rapid startup and shutdown dynamics are desirable.

In the prior art, microstructured reactors are known, which have the advantages of a high heat transfer performance per unit area and of a compact design. Such microstructured reactors have to date been sold commercially for laboratory applications in the prior art. A comprehensive review of the prior art is disclosed, for example, in V. Hessel, S. Hardt, H. Löwe, Chemical Micro Process Engineering, 2004, Wiley VCH.

The use of microstructured reactors to prepare HCN is mentioned in the prior art below, but there is no mention of the preparation of HCN by dehydration of formamide.

DE-A 10 2005 051637 discloses a specific reactor system comprising a microstructured reactor having a reaction zone for performing high temperature gas phase reactions, said reaction zone being heated by means of a heat source. The heat source comprises contactless heating. The reactor system is suitable for catalytic high temperature gas phase applications, mention being made of HCN synthesis by the Andrussow process (oxidation of a mixture of ammonia and methane at approx. 1100° C. over a Pt catalyst (generally a Pt mesh with 10% Rh)), by the Degussa-BMA process (catalytic conversion of ammonia and methane to hydrogen cyanide and hydrogen at approx. 1100° C.) and by the Shavinigan process (conversion of propane and ammonia in the absence of a catalyst at temperatures of generally >1500° C., in which the heat of reaction is supplied with the aid of a directly heated fluidized bed composed of carbon particles). A significant aspect in DE-A 10 2005 05 1637 is the provision of a suitable heat source for a microstructured reactor which is suitable for high temperature gas phase reactions. From a process technology point of view, these typical high temperature gas phase reactions differ significantly from the process for preparing hydrogen cyanide by means of formamide cleavage, which comprises two stages, specifically the evaporation of formamide which is liquid at room temperature (boiling point: 210° C.) and the subsequent catalytic cleavage to hydrogen cyanide and water (catalytic dehydration). The cleavage of formamide is effected generally at significantly lower temperatures, of typically from 350 to 650° C., compared with the aforementioned processes for preparing hydrogen cyanide. According to DE-A 10 2005 051637, the reaction channels of the reactor system used may be coated with ceramic layers or with a supported catalyst, in which case a catalytically active metal, especially selected from Pt, Pd, Rh, Re, Ru or mixtures or alloys of these metals, is applied to a so-called “washcoat”, which is typically aluminum oxide or hydroxide.

DE-A 199 45 832 discloses a modular microreactor which is formed from a casing, a casing lid and catalytically active, exchangeable units. The microreactor is said to be suitable for high temperature reactions at temperatures up to 1400° C. Illustrative syntheses mentioned are the synthesis of ethene by methane coupling, HCl oxidation by the Deacon process and HCN synthesis by the Degussa process and by the Andrussow process. A significant aspect of the microreactor disclosed in DE-A 199 45 832 is the exchangeability of the individual components, especially the catalytically active internals, of the reaction module. Compared to this, in the process for preparing hydrogen cyanide by formamide decomposition, no catalytically active internals are required, and it is instead sufficient for the inner wall of the reactor to be catalytically active. The material used for the microreactor is preferably ceramic.

In the process for preparing hydrogen cyanide by the dehydration of formamide, by-products are obtained—to a minor degree—which lead to deposits in the reaction channels. These deposits are especially problematic in reaction channels with very small diameters of <1 mm, since they become blocked rapidly and necessitate shutdown of the reactor. Furthermore, the use of catalysts and internals in the reaction channels is problematic, since deposits can likewise form on the catalysts and internals.

It is therefore an object of the present invention, with respect to the aforementioned prior art, to provide a process for preparing hydrogen cyanide by catalytically dehydrating gaseous formamide, which has high conversions and a high selectivity for the desired hydrogen cyanide and can be conducted in reactors with a compact design coupled with economically sufficiently long service lives of the reactors.

This object is achieved by a process for preparing hydrogen cyanide by catalytically dehydrating formamide in a tubular reactor formed from at least one reaction channel in which the catalytic dehydration proceeds, said reaction channel having an inner surface which is formed from a material having an iron content of 50% by weight, and no additional catalysts and/or internals being present in the reaction channel.

In the process according to the invention, the at least one reaction channel has a mean hydraulic diameter of from 0.5 to 6 mm, preferably from >1 to 4 mm, more preferably from >1 to 3 mm.

It has been found that, surprisingly, with the same length of the reaction tube of the tubular reactor and the same formamide loading, smaller tube diameters (channel geometries) do not lead to any significant reduction in the conversion to the desired hydrogen cyanide, in spite of the significantly higher surface loading coupled with small channel geometries. In addition, it has been found that blockage of the reaction tubes of the tubular reactor by deposits can be prevented by dimensioning the reaction tubes within the millimeter range from 0.5 to 6 mm, preferably from >1 to 4 mm, more preferably from >1 to 3 mm, and so long service lives of the tubular reactor can be achieved.

The hydraulic diameter dₕ is a theoretical parameter with which calculations can be carried out on tubes or channels with a noncircular cross section. The hydraulic diameter is the quotient of four times the flow cross section A and the circumference U of a measured cross section wetted by the fluid:

dₕ=4A/U

The mean hydraulic diameter is based in each case on a reaction channel of the reactor used in accordance with the invention.

The inner surface of the reaction channel is understood to mean the surface of the reaction channel which is in direct contact with the reactants, i.e. including the gaseous formamide.

Preference is given to using, in the process according to the invention, a tubular reactor which is formed from at least one reaction channel with a mean hydraulic diameter of from 0.5 to 6 mm, preferably from >1 to 4 mm, more preferably from >1 to 3 mm, in which the catalytic dehydration proceeds, and at least one channel with a mean hydraulic diameter of <4 mm, preferably from 0.2 to 3 mm, more preferably from 0.5 to 2 mm, through which a heat carrier flows.

The heat carrier is a heating medium suitable for injecting heat. Suitable heating media are known to those skilled in the art. Suitable heating media are, for example, flue gases with gas circulation.

The tubular reactor is preferably formed from at least two parallel layers A and B arranged one on top of the other, the layer A having at least two reaction channels which are arranged parallel to one another and have a mean hydraulic diameter of from 0.5 to 6 mm, preferably from >1 to 4 mm, more preferably from >1 to 3 mm, in which the catalytic dehydration proceeds, and the layer B having at least two channels which are arranged parallel to one another and have a mean hydraulic diameter of <4 mm, preferably from 0.2 to 3 mm, more preferably from 0.5 to 2 mm, through which a heat carrier flows.

In the context of the present application, a layer is understood to mean a substantially two-dimensional, flat component, i.e. a component whose thickness is negligibly small in relation to its area. The layer is preferably an essentially flat panel which is structured to form the aforementioned channels.

Typically, the tubular reactor has from two to 1000, preferably from 40 to 500, alternating layers A, in which the catalytic dehydration proceeds, and layers B through which a heat carrier flows, said layers A and B being arranged one on top of the other, such that each individual layer has a multitude, preferably from 10 to 500, more preferably from 20 to 200, of channels which are arranged in parallel and form a continuous flow path from one side of the layer to the opposite side thereof.

As already mentioned, the gaseous formamide to be dehydrated flows through the particular layers A, and a heat carrier flows through the layers B.

As already mentioned above, in alternation with the layers A through which gaseous formamide flows are arranged layers B, to which is fed a heat carrier on one side of the particular layer and from which the heat carrier is drawn off on the other side of the particular layer. In the context of the present application, an alternating arrangement of the layers A and B should be understood to mean that each layer A is followed by a layer B, or that two or more successive layers A are followed in each case by a layer B, or that one layer A is followed in each case by two or more successive layers B. At the same time, a plurality of layers A and/or B arranged one on top of the other may be appropriate in order to adjust different flows of heat carrier (heating medium) and formamide by free selection of the number of channels and the number of layers A and B such that the pressure drop desired over the channels can be established in a controlled manner on the reaction side (layer A, in which the catalytic dehydration proceeds) and the heat carrier side (layer B).

Preferably, in the process according to the invention, a pressure drop which is <2 bar, more preferably from 0.02 to 1 bar, is established.

The channels of layers A and B can be arranged so as to give rise to a crosscurrent, countercurrent or cocurrent regime. In addition, any desired mixed forms are conceivable.

Typically provided, in the reactor used in accordance with the invention, for the channels of the layers A, are, at one end of the layers A, a distributor device for the supply of the reactants (of the gaseous formamide) and, at the other end of the layers A, a collector device for the reaction product (hydrogen cyanide). One distributor device generally supplies all layers A. In addition, one collector device is generally provided for all layers A. Typically, all layers A form a continuous system of reaction channels.

In general, for the layers B too, through whose channels a heat carrier flows, in each case one distributor and one collector device are provided corresponding to the distributor and collector devices relating to the layers A. Typically, all layers B form a continuous system of channels through which heat carrier flows.

In one embodiment of the reactor used in accordance with the invention, the distributor and collector device is in each case configured as a chamber arranged outside the stack of layers A and/or B. In this case, the walls of the chamber may be straight or, for example, curved in a semicircular shape. What is essential is that the geometric shape of the chambers is suitable for configuring flow and pressure drop so as to achieve homogeneous flow through the channels.

In a further embodiment, the distributor and collector devices are each arranged within the stack of layers A and/or B, by virtue of the channels of each layer A and B which are arranged parallel to one another having, in the region of each of the two ends of the layer, in each case a cross channel which connects the channels arranged parallel to one another, and by virtue of all cross channels within the stack of layers A and/or B being connected by a collector channel arranged essentially at right angles to the plane of layers A and/or B. In this case too, it is essential that the geometric shape of the chamber is suitable for configuring flow and pressure drop so as to achieve homogeneous flow through the channels. Suitable geometric shapes of the chamber are specified in the aforementioned embodiments and are known to those skilled in the art.

The process according to the invention can be carried out at a uniform temperature (specified below). However, it is likewise possible that the process according to the invention is carried out in such a way that a temperature profile is passed through along the channels of each layer A, in which two or more, preferably from two to three, heating zones per layer, with in each case at least one distributor and collector device per heating zone of the layers B, are provided for appropriate temperature control in the channels of the layers A. The temperature profile is established within the temperature range specified below for performance of the catalytic dehydration of formamide.

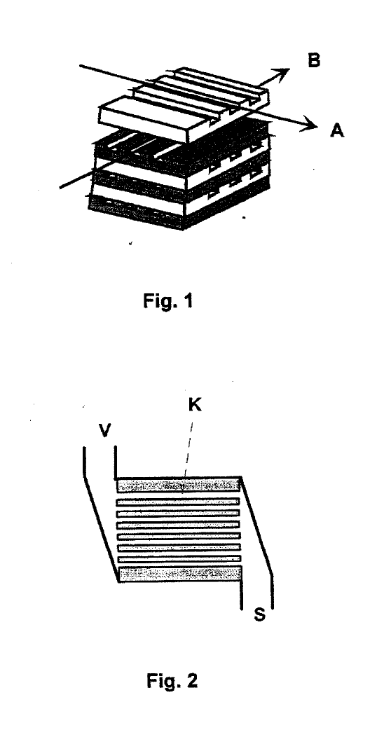

FIG. 1 shows, by way of example, a schematic three-dimensional section of an inventive reactor, the layers A and B being arranged alternately in FIG. 1, each layer A being followed by a layer B, and the arrangement of layers A and B being such as to give rise to crosscurrent flow.

In FIG. 1:

A means layers A through which formamide flows

B means layers B through which heat carrier (heating medium) flows.

The arrows in each case indicate the flow direction of the formamide or of the heating medium.

FIG. 2 shows, by way of example, a schematic plan view of a layer, which may be a layer A or B. Within the layer, a distributor device V and a collector device S are shown schematically.

In FIG. 2,

V means distributor device
S means collector device
K means channels.

The reactor preferably used in accordance with the invention can be produced by the process known to those skilled in the art. Suitable processes are disclosed, for example, in V. Hessel, H. Löwe, A. Müller, G. Kolb, Chemical Micro Process Engineering-Processing and Plants, Wiley-VCH, Weinheim, 2005, pp. 385 to 391 and W. Ehrfeld, V. Hessel, V. Haverkamp, Microreactors, Ullmann's Encyclopedia of Industrial Chemistry, Wiley-VCH, Weinheim 1999. Typically, the production comprises the generation of a microstructure in the individual layers by processing panels of materials suitable for the reactor, the stacking of the layers, the joining of the layers to assemble the reactor and the insertion of connections for the input of the gaseous formamide and the output of the hydrogen cyanide and if appropriate for the input and output of the heat carrier. DE-A 10 2005 051 637 describes various production processes for microstructured reactors which can be employed correspondingly to produce the reactor used in accordance with the invention.

Suitable materials of the reactor used in accordance with the invention are likewise known to those skilled in the art, the reaction channel having an inner surface which is formed from a material having an iron content of ≧50% by weight. In a particularly preferred embodiment, the inner reactor surface is formed from steel, which more preferably comprises iron and also chromium and nickel. The proportion of iron in the steel which preferably forms the inner reactor surface is generally ≧50% by weight, preferably ≧60% by weight, more preferably ≧70% by weight. The remainder is generally nickel and chromium, and it is possible if appropriate for small amounts of further metals such as molybdenum, manganese, silicon, aluminum, titanium, tungsten, cobalt with a proportion of generally from 0 to 5% by weight, preferably from 0 to 2% by weight to be present. Steel qualities suitable for the inner reactor surface are generally steel qualities corresponding to standards 1.4541, 1.4571, 1.4573, 1.4580, 1.4401, 1.4404, 1.4435, 2.4816, 1.3401, 1.4876 and 1.4828. Preference is given to using steel qualities corresponding to standards 1.4541, 1.4571, 1.4828, 1.3401, 1.4876 and 1.4762, particular preference being given to steel qualities corresponding to standards 1.4541, 1.4571, 1.4762 and 1.4828.

With the aid of such a tubular reactor, catalytic dehydration of gaseous formamide to hydrogen cyanide by the process according to the invention is possible without having to use additional catalysts or the reactor having additional internals.

Preference is given to performing the process according to the invention in the presence of oxygen, preferably atmospheric oxygen. The amounts of oxygen, preferably atmospheric oxygen, are generally from >0 to 10 mol %, based on the amount of formamide used, preferably from 0.1 to 10 mol %, more preferably from 0.5 to 3 mol %. To this end, gaseous formamide (formamide vapor) can be admixed with oxygen, preferably atmospheric oxygen, before being supplied to the tubular reactor.

The catalytic dehydration in the process according to the invention is effected generally at temperatures of from 350 to 650° C., preferably from 450 to 550° C., more preferably from 500 to 550° C. When, however, higher temperatures are selected, worsened selectivities and conversions are to be expected.

The pressure in the process according to the invention for catalytically dehydrating gaseous formamide is generally from 100 mbar to 4 bar, preferably from 300 mbar to 3 bar.

Hereinabove and hereinbelow, the pressure in the context of the present application is understood to mean the absolute pressure.

The optimal residence time of the formamide gas stream in the process according to the invention is calculated from the length-specific formamide loading, which is preferably from 0.02 to 0.4 kg/(mh), preferably from 0.05 to 0.3, more preferably from 0.08 to 0.2, in the range of laminar flow. The optimal residence time therefore depends on the tube diameter. Low tube diameters therefore give rise to shorter optimal residence times. As mentioned above, the above-specified value of the length-specific formamide loading applies to the range of laminar flow. In the case of turbulent flow, the loading may be higher.

The gaseous formamide used in the process according to the invention is obtained by evaporating liquid formamide. Suitable processes for evaporating liquid formamide are known to those skilled in the art and are described in the prior art mentioned in the introductory part of the description.

Preference is given to evaporating the liquid formamide in an evaporator at temperatures of from 200 to 300° C., preferably from 210 to 260° C., more preferably from 220 to 240° C. The pressure in the evaporation of the liquid formamide is typically from 400 mbar to 4 bar, preferably from 600 mbar to 2 bar, more preferably from 800 mbar to 1.4 bar.

In a preferred embodiment, the evaporation of the liquid formamide is carried out with short residence times. Particularly preferred residence times are <20 s, preferably <10 s, based in each case on the liquid formamide.

Owing to the very short residence times in the evaporator, the formamide can be evaporated virtually completely without by-product formation.

The aforementioned short residence times of the formamide in the evaporator are preferably achieved in microstructured apparatus. Suitable microstructured apparatus which can be used as an evaporator are described, for example, in DE-A 101 32 370, WO 2005/016512 and WO 2006/108796.

A particularly preferred process for evaporating liquid formamide and microevaporators used with particular preference are described in the application which was filed on the same date and has the title “Improved process for preparing hydrogen cyanide by catalytic dehydration of gaseous formamide—evaporation of liquid formamide” with reference number EP 07 120 540.5, whose disclosure content is explicitly incorporated by reference.

More preferably, the gaseous formamide used in the process according to the invention for dehydrating gaseous formamide is therefore obtained by evaporation in a microstructured evaporator.

When a microstructured evaporator is used in combination with the reactor used in accordance with the invention, it is possible to provide particularly compact and cost-saving plants for preparing hydrogen cyanide from formamide.

The process according to the invention for preparing hydrogen cyanide affords the desired hydrogen cyanide in high selectivities of generally >90%, preferably >95%, and conversions of generally >90%, preferably >95%, so as to achieve yields of generally >80%, preferably >85%, more preferably >88%.

The present invention further provides a reactor formed from at least two parallel layers A and B arranged one on top of the other, the layer A having at least two reaction channels which are arranged parallel to one another and have a mean hydraulic diameter of from 0.5 to 6 mm, preferably from >1 to 4 mm, more preferably from >1 to 3 mm, and the layer B has at least two channels which are arranged parallel to one another and have a mean hydraulic diameter of from <4 mm, preferably from 0.2 to 3 mm, more preferably from 0.5 to 2 mm.

Preferred embodiments and suitable preparation processes relating to the aforementioned reactor are specified above.

More preferably, the reactor additionally comprises a microevaporator, especially a microevaporator as disclosed in the application which was filed on even date with the title “Improved process for preparing hydrogen cyanide by catalytic dehydration of gaseous formamide—evaporation of liquid formamide” and reference number EP 07 120 540.5, said microevaporator having an outlet for gaseous formamide and the tubular reactor having an inlet for gaseous formamide, and the outlet of the microevaporator being connected to the inlet of the inventive reactor via a line for gaseous formamide.

Suitable embodiments of the inventive reactor for dehydrating formamide can be constructed without any problem by a person skilled in the art on the basis of the above information. Suitable combinations of microevaporators and inventive reactors can also be constructed without any problem by a person skilled in the art on the basis of the above information.

With the aid of the present invention, it is possible to provide plants for preparing hydrogen cyanide which are significantly smaller than plants used customarily to prepare hydrogen cyanide. Such plants are more mobile and therefore more versatile, and can, for example, be constructed where hydrogen cyanide is required, such that transport of hydrogen cyanide or salt in the hydrogen cyanide (for example alkali metal and alkaline earth metal salts) over long distances can be avoided. The present invention further provides for the use of the inventive reactor (micro-millichannel reactor) for preparing hydrogen cyanide by catalytically dehydrating gaseous formamide.

Preferred embodiments of the reactor and a preferred process for preparing hydrogen cyanide from formamide have been mentioned above.

The examples which follow provide additional illustration of the invention.

### EXAMPLES

The experiments are carried out with tubular reactors of length 40 mm. The test setup comprises a silver block into which the reaction tube is inserted with an exact fit. The tube consists of 1.4541 steel. The silver block is heated with heating rods. The good heat transfer in the silver bed allows isothermal operation of the tube wall to be ensured. The reactor is charged with vaporous formamide and is operated at a pressure of 300 mbar and 520° C.

### Example 1

### Comparative

The experiment is carried out as described above. The reaction tube used is a tube of internal diameter 12 mm. Pressure: 300 mbar

TABLE 1
Overview of the result of formamide decomposition
in a 12 mm tubular reactor

| Formamide supply | Conversion | HCN selectivity |
|---|---|---|
| 200 g/h | 79% | 95 |

### Example 2

### Inventive

The experiment is carried out as described above. The reaction tube used is a tube of internal diameter 3 mm. Pressure: 300 mbar

TABLE 2
Overview of the result of formamide decomposition
in a 3 mm tubular reactor

| Formamide supply | Conversion | HCN selectivity |
|---|---|---|
| 200 g/h | 78% | 95 |

The examples show that the conversion of formamide and the HCN selectivity are surprisingly independent of the diameter of the reaction tube.

1. A process for preparing hydrogen cyanide comprising catalytically dehydrating gaseous formamide in a tubular reactor formed from at least a first reaction channel in which a catalytic dehydration proceeds,
wherein the at least first said reaction channel having has an inner surface formed from a material having an iron content of ≧50% by weight, wherein no additional catalyst and/or internal is present in the at least first reaction channel, and wherein the at least first reaction channel has a mean hydraulic diameter of >1 to 3 mm.

2. The process according to claim 1, wherein the tubular reactor is formed from the at least first reaction channel with a mean hydraulic diameter of >1 to 3 mm, in which the catalytic dehydration proceeds, and at least a first heat carrier channel with a mean hydraulic diameter of <4 mm, through which a heat carrier flows.

3. The process according to claim 1, wherein the tubular reactor is formed from at least a first layer A and a second layer B, which are parallel and arranged one on top of the other, wherein the at least first layer A comprises at least a first reaction channel and a second reaction channel, which are arranged parallel to one another and have a mean hydraulic diameter of >1 to 3 mm, in which the catalytic dehydration proceeds, and wherein the at least second layer B comprises at least a first heat carrier channel and a second heat carrier channel, which are arranged parallel to one another and have a mean hydraulic diameter of <4 mm, through which a heat carrier flows.

4. The process according to claim 1, wherein the at least first reaction channel of the tubular reactor has an inner surface formed from a steel, wherein the proportion of iron in the steel is ≧60% by weight.

5. The process according to claim 1, wherein the catalytic dehydration is carried out at a temperature of 350 to 650° C.

6. The process according to claim 1, wherein the catalytic dehydration is carried out at a pressure of 100 mbar to 4 bar.

7. The process according to claim 1, wherein the catalytic dehydration is effected at a length-specific formamide loading of 0.02 to 0.4 kg/(mh) in the range of laminar flow.

8. The process according to claim 1, wherein the catalytic dehydration is effected in the presence of atmospheric oxygen.

9. The process according to claim 1, wherein gaseous formamide is obtained by evaporating liquid formamide in an evaporator at a temperature of 200 to 300° C.

10. The process according to claim 9, wherein the formamide is evaporated at a pressure of 400 mbar to 4 bar.

11. The process according to claim 9, wherein the formamide is evaporated at a residence time of the formamide in the evaporator of <20 s, based on liquid formamide.

12. The process according to claim 9, wherein the evaporator is a microstructured apparatus.

13. A reactor formed from at least a first layer A and a second layer B, which are parallel and arranged one on top of the other, wherein the at least first layer A comprises at least a first reaction channel and a second reaction channel, which are arranged parallel to one another and have a mean hydraulic diameter of >1 to 3 mm, and wherein the at least second layer B comprises at least a first heat carrier channel and a second heat carrier channel, which are arranged parallel to one another and have a mean hydraulic diameter of <4 mm, through which a heat carrier flows, the at least first reaction channel and second reaction channel have an inner surface which is formed from a material having an iron content of ≧50% by weight, and wherein no additional catalyst and/or internal is present in the at least first reaction channel and second reaction channel.

14. The method of for preparing hydrogen cyanide, comprising catalytically dehydrating gaseous formamide in the reactor according to claim 13.
